(19) United States
(12) Patent Application Publication
(10) Pub. No.: US 2013/0246968 A1
(43) Pub. Date: Sep. 19, 2013

(54) OPERATION SUPPORTING DISPLAY APPARATUS AND METHOD

(71) Applicant: TOSHIBA TEC KABUSHIKI KAISHA, Tokyo (JP)

(72) Inventors: Katsuhito Mochizuki, Shizuoka-ken (JP); Masanori Sambe, Shizuoka-ken (JP)

(73) Assignee: TOSHIBA TEC KABUSHIKI KAISHA, Tokyo (JP)

(21) Appl. No.: 13/780,195

(22) Filed: Feb. 28, 2013

(30) Foreign Application Priority Data
Mar. 5, 2012 (JP) 2012-048563

(51) Int. Cl. G06F 3/0481

(52) U.S. Cl. CPC G06F 3/04812
USPC 715/788

(57) ABSTRACT

An operation supporting display apparatus comprises: an action recognition apparatus configured to recognize the position and action of a user; a display control unit configured to display after superimposing sub window for displaying an operation guidance showing the state of replacing the recognition action information recognized by the action recognition apparatus with an operation that corresponds to the output of a pointing device for the image displaying on a display unit over the image; and an action reflection unit configured to reflect the position and action of the user based on the recognition action information recognized by the action recognition apparatus as the user operation; wherein the display control unit updates the operation guidance of the sub window in accordance with the user operation reflected by the action reflection unit.

### CROSS-REFERENCE TO RELATED APPLICATION

This application is based upon and claims the benefit of priority from Japanese Patent Application No. 2012-048563, filed Mar. 5, 2012, the entire contents of which are incorporated herein by reference.

### FIELD

Embodiments described herein relate to an operation supporting display apparatus and method.

### BACKGROUND

As a apparatus for displaying digitalized contents such as advertisements, events and notices to unspecified people, a system for displaying digitalized contents on a Signage terminal (e.g. display), that is, the called Digital Signage system, is known.

Besides, an action recognition apparatus has been developed in recent years which measures the distance between the action recognition apparatus and the user reflected on a camera while measuring the body action of the user. Efforts are being made to realize the implementation of various operations by using the recognition result of such an action recognition apparatus on the position and action of a user as the output of a pointing device.

### BRIEF DESCRIPTION OF THE DRAWINGS

FIG. 1 is a block diagram showing the structure of an information processing system according to an embodiment.

FIG. 2 is a front view showing the external appearance of a signage terminal apparatus.

FIG. 3 is a block diagram showing the structure of a signage terminal apparatus.

FIG. 4 is a block diagram showing the functional structure of a signage terminal apparatus.

FIG. 5 is a front view of an example of a display screen.

FIG. 6 is a flowchart illustrating the flow of an operation supporting display processing.

FIG. 7 is a diagram illustrating the transition of a screen.

### DETAILED DESCRIPTION

In accordance with an embodiment, an operation supporting display apparatus comprises: an action recognition apparatus configured to recognize the position and action of a user; a display control unit configured to display after superimposing sub window for displaying an operation guidance showing the state of replacing the recognition action information recognized by the action recognition apparatus with an operation that corresponds to the output of a pointing device for the image displaying on a display unit over the image; and an action reflection unit configured to reflect the position and action of the user based on the recognition action information recognized by the action recognition apparatus as the user operation; wherein the display control unit updates the operation guidance of the sub window in accordance with the user operation reflected by the action reflection unit.

In accordance with an embodiment, a method comprises: recognizing the position and action of a user; displaying after superimposing sub window for displaying an operation guidance showing the state of replacing the recognition action information recognized by an action recognition apparatus with an operation that corresponds to the output of a pointing device for the image displaying on a display unit over the image; reflecting the position and action of the user based on the recognition action information recognized by the action recognition apparatus as the user operation; and updating the operation guidance of the sub window in accordance with the user operation reflected by the action reflection unit.

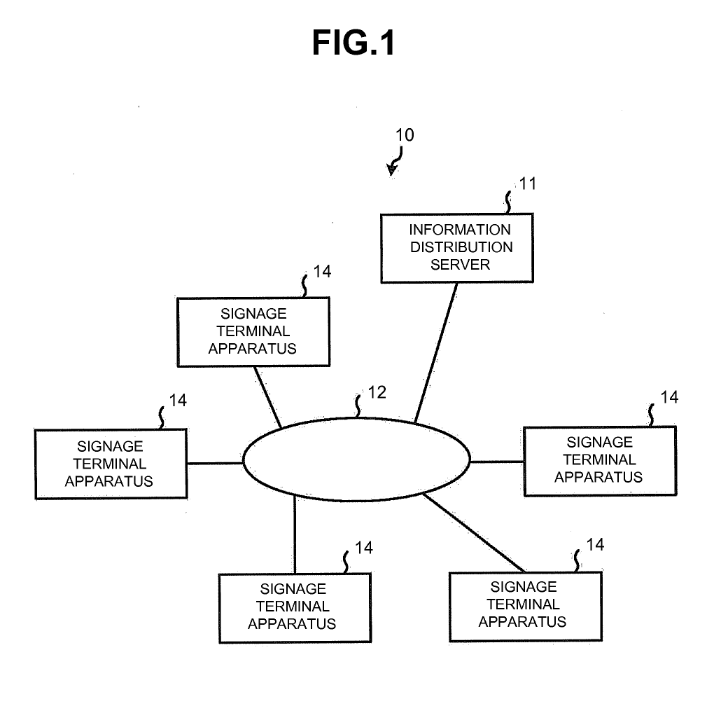

FIG. 1 is a block diagram illustrating the structure of an information processing system 10 according to the embodiment. The description given below is based on the installation of the information processing system provided in the embodiment in a shopping mall.

In accordance with the embodiment, an information processing system 10 comprises: an information distribution server 11 serving as a digital signage management apparatus, and a plurality of signage terminal apparatuses 14 serving as digital signage regenerators.

The information distribution server 11 is connected with the signage terminal apparatuses 14 via a communication network 12 such as an LAN (Local Area Network) to distribute the content of the advertisement information or event information of a commodity to the signage terminal apparatuses 14 and acquire contents by means of the access of the signage terminal apparatuses 14.

The signage terminal apparatuses 14 regenerate and display the content data distributed or acquired by the information distribution server 11 via the communication network 12.

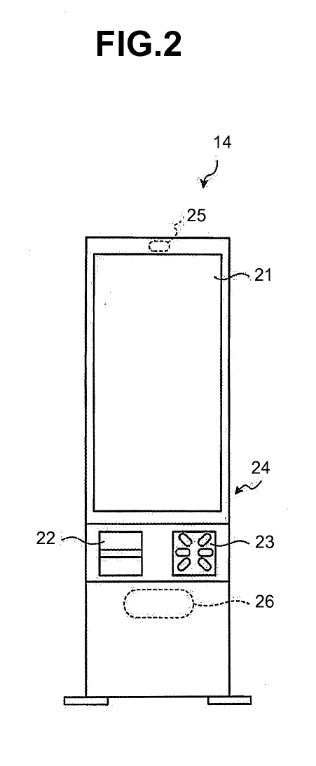

FIG. 2 is a front view illustrating the external appearance of the signage terminal apparatus. The signage terminal apparatus 14 comprises: a display portion, that is, a display unit 21, in the form of a liquid crystal display or a plasma display; a printer unit 22 configured to print and issue various tickets or coupons; and a casing unit 24 configured to support the display unit 21 and the printer unit 22.

An action recognition apparatus 25 and a loudspeaker unit 26 for outputting various sounds such as background music (BGM) or advertising sound are configured on the internal upper portion of the casing unit 24. Further, an image recognition processing may be carried out in an upstream server such as the information distribution server 11, but not in the signage terminal apparatus 14.

The action recognition apparatus 25, which includes, for example, a camera, a sensor and a processor, recognizes the position, action and face of a user facing the signage terminal apparatus 14. More specifically, the action recognition apparatus 25 measures the distance between the user reflected on the camera and the action recognition apparatus and detects the body action of the user.

FIG. 3 is a block diagram illustrating the structure of the signage terminal apparatus 14. The signage terminal apparatus 14 includes: the display unit 21, the printer unit 22, the action recognition apparatus 25, the loudspeaker unit 26, a controller 31 configured to control the whole signage terminal apparatus 14, an operation unit 32 for the user to execute various operations, a network communication interface (IF) 33 configured to communicate with the information distribution server 11 via the communication network 12, a near-distance wireless communication unit 23, an information distribution communication interface (IF) 34 for distributing the information relative to advertisement information or event information to a portable information terminal apparatus 13 and an external storage apparatus 35 configured to store various data.

Here, the controller 31 comprises: an MPU (Micro Processing Unit) 36 for controlling the whole controller 31, an ROM (Read Only Memory) 37 for storing the control program executed by the MPU 36 and an RAM (Random Access Memory) 38 for storing various data temporarily. Then, the MPU 36 executes the control program stored in the ROM 37 in order that the controller 31 regenerates the content distributed by the information distribution server 11 via the communication network 12 and displays the regenerated content on the display unit 21. Besides, the operation unit 32 consisting of various switches and buttons may also be integrated with the display unit 21 serving as a pointing device (that is, a touch panel).

Further, in the embodiment, the action recognition apparatus 25 also functions as a pointing device. More specifically, the controller 31 may operate the content displayed in the display unit 21 based on the recognition result (the action or the position of the hand of the user) recognized by the action recognition apparatus 25.

However, in the case where the recognition result of the action recognition apparatus 25 is used as the output of the pointing device, as the user does not contact a direct interface apparatus different from a mouse or touch panel directly, no sensible feedback is generated. Thus, in the prior art, the user can only determine an operation condition with reference to the situation shown on the screen.

Next, the distinctive functions of the operation supporting display apparatus, that is, the signage terminal apparatus 14, provided in the embodiment to solve the problem above are described.

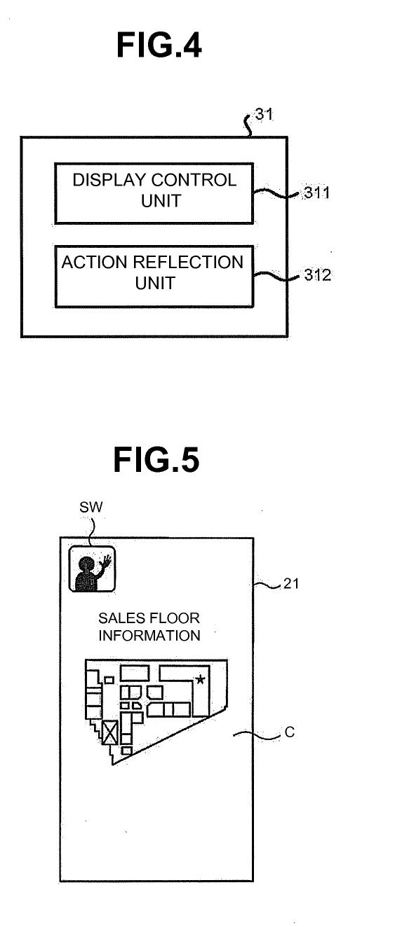

FIG. 4 is a block diagram illustrating the functional structure of the signage terminal apparatus 14. The controller 31 operates the MPU 36 in accordance with the control program stored in the ROM 37 to function as a display control unit 311 and an action reflection unit 312, as shown in FIG. 4.

The display control unit 311 additionally distributes information (e.g. display position, display icon) for displaying an operation supporting sub window SW (refer to FIG. 5) supportive to an operation on the content image that is distributed to the signage terminal 14 to be displayed on the display unit 21. Further, in the case where the recognition result of the action recognition apparatus 25 is obtained based on the superimposing of the indicator pointer of the user on the operation supporting sub window SW, the display control unit 311 moves the display position of the operation supporting sub window SW. Thus, the operation of the user may not be influenced. Further, the display control unit 311 may move the operation supporting sub window SW in synchronization with the movement of the indicator pointer of the user to replace a cursor.

Here, FIG. 5 is a front view of an example of a display screen displayed on the display unit 21 of the signage terminal apparatus 14. As shown in FIG. 5, when the operation unit 32 is required to be operated to determine the content to be regenerated in the signage terminal apparatus 14, the display control unit 311 displays content C on the display unit 21. Further, the display control unit 311 displays the operation supporting sub window SW by superimposing the operation supporting sub window SW on the content C displayed on the display unit 21 of the signage terminal apparatus 14.

The operation supporting sub window SW displays an operation guidance for an operation of using the recognition action information recognized by the action recognition apparatus 25 as the output of the pointing device.

The action reflection unit 312 acquires the recognition action information recognized by the action recognition apparatus 25 which recognizes the position or operation action of a user according to the display content of the operation supporting sub window SW displayed on the display unit 21 of the signage terminal apparatus 14 and reflects the position and action of the user as an user operation.

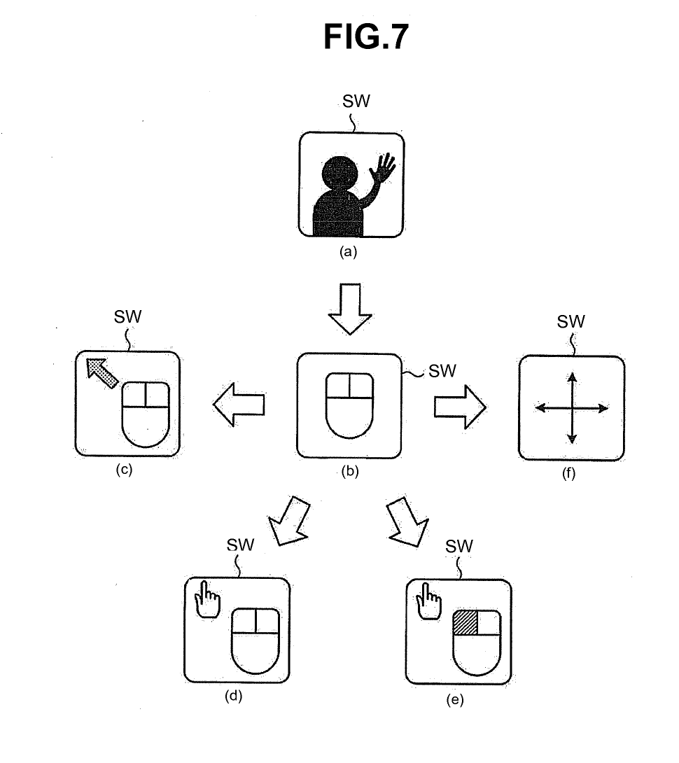

Next, an operation supporting display processing carried out in the signage terminal apparatus 14 is described in detail. Here, FIG. 6 is a flowchart illustrating the flow of an operation supporting display processing carried out in the signage terminal apparatus 14, and FIG. 7 is a diagram illustrating the transition of a screen displayed on the display unit 21 of the signage terminal apparatus 14.

The display control unit 311 regenerates the content distributed by the information distribution server 11 in the order in which these contents are received and displays the image of the regenerated content on the display unit 21 (ACT S1) and, if the recognizable area of the action recognition apparatus 25 is reflected by the user to start a recognition on the action of the user (ACT S2: Yes), displays an operation guidance in the case of using the recognition action information recognized by the action recognition apparatus 25 as the output of pointing device, as the operation supporting sub window (SW) (ACT S3).

For example, an icon ‘start’ A representing the action of a gesture starting an operation supporting display processing serving as an operation guidance is displayed in the initial screen of the operation supporting sub window (SW) shown in FIG. 7 (a). The icon ‘start’ A signifies ‘the rise of the right hand’ with a simple pattern. Further, the action represented in the icon ‘start’ A may be ‘swing hand to the right’, ‘swing hand to the left’ and so on. Further, a description or words may be added if picture is not expressive enough.

Sequentially, if the display control unit 311 determines that a processing is started (ACT S4: Yes), by receiving, from the action recognition apparatus 25, recognized recognition action information indicating that the user rises his right hand with reference to the icon ‘start’ A, then an operation supporting display processing is started (ACT S6). In addition, the icon displayed on the operation supporting sub window SW is pre-associated with the recognized recognition action information received from the action recognition apparatus 25 and stored in a table stored in the external storage apparatus 35.

If the operation supporting display processing is started, the action reflection unit 312 displays the state of replacing the recognition action information received from the action recognition apparatus 25 with an operation that corresponds to the output of a pointing device on the sub window SW. In addition, as the result of the start of the operation supporting display processing, the indicator pointer (cursor) of the pointing device is displayed with the display of the operation supporting sub window SW, meanwhile, the indicator pointer (cursor) moves with action of the hand of the user.

For example, in the operation supporting sub window SW shown in FIG. 7(b), the recognized recognition action information indicating ‘no action of the user’ is updated by being replaced by an operation guidance for an operation state equivalent to a state in which the movement of a mouse is disenabled.

For example, in the operation supporting sub window SW shown in FIG. 7(c), the recognized recognition action information indicating ‘the user moves his hand from right to left’ is updated by being replaced by an operation guidance for an operation state equivalent to a state in which a mouse is moved.

Further, in the operation supporting sub window SW shown in FIG. 7(d), the recognized recognition action information indicating ‘the user temporarily stops moving his hand’ is replaced by an operation guidance for an operation state equivalent to a state in which the movement of a mouse is stopped temporarily.

Further, in the operation supporting sub window SW shown in FIG. 7(e), the recognized recognition action information indicating ‘the user clicks with fingers’ is replaced by an operation guidance for an operation state equivalent to a state in which a mouse is clicked.

Further, in the operation supporting sub window SW shown in FIG. 7(f), the recognized recognition action information indicating ‘the user closes his hand to the signage terminal apparatus 14 to click’ is replaced by an operation guidance for an operation state equivalent to a flicking state.

Thus, in accordance with the embodiment, an operation supporting display apparatus comprises: a display control unit 311 configured to superimpose, on an content image displaying the recognition action information recognized by an action recognition apparatus 25 on a display unit 21, an operation supporting sub window SW for displaying an operation guidance for an operation equivalent to the replacement of the content image with the output of a pointing device; and an action reflection unit 312 configured to reflect, based on the recognition action information recognized by the action recognition apparatus 25, the position and action of a user as a user operation, wherein the display control unit 311 updates the operation guidance of the sub window SW in accordance with the user operation reflected in the action reflection unit 312. Thus, in accordance with the embodiment, the user which implements an operation in accordance with the content displayed on the display unit 21 can appreciate the current operation content by reading the operation guidance displayed on the operation supporting sub window SW, thus, the user can receive a feedback on an operation.

Further, as the operation support display processing is carried out at the side of the signage terminal apparatus 14, there is no need to install a member for sensing the processing at the side of the information distribution server 11.

In this embodiment, the signage terminal apparatus 14 may be applied as an operation supporting display apparatus, as well as an information processing apparatus such as a personal computer.

The program executed by the signage terminal apparatus 14 in this embodiment may be stored in a computer-readable memory medium such as a CD-ROM, a floppy drive (FD), CD-R, a digital versatile disk (DVD) as an installable or executable file.

In addition, the program executed by signage terminal apparatus 14 in this embodiment may be distributed or provided through a network such as the Internet.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An operation supporting display apparatus, comprising:
an action recognition apparatus configured to recognize the position and action of a user;
a display control unit configured to display after superimposing sub window for displaying an operation guidance showing the state of replacing the recognition action information recognized by the action recognition apparatus with an operation that corresponds to the output of a pointing device for the image displaying on a display unit over the image; and
an action reflection unit configured to reflect the position and action of the user based on the recognition action information recognized by the action recognition apparatus as the user operation; wherein
the display control unit updates the operation guidance of the sub window in accordance with the user operation reflected by the action reflection unit.

2. The operation supporting display apparatus according to claim 1, wherein
the display control unit displays an icon representing the action of a gesture indicating the start of an operation supporting display processing in the initial screen of the sub window as the operation guidance.

3. The operation supporting display apparatus according to claim 1, wherein
the display control unit moves the display position of the sub window in the case that the indicator pointer by the user superimposes over the sub window as the recognition result of the action recognition apparatus.

4. A method, comprising:
recognizing the position and action of a user;
displaying after superimposing sub window for displaying an operation guidance showing the state of replacing the recognition action information. recognized by an action recognition apparatus with an operation that corresponds to the output of a pointing device for the image displaying on a display unit over the image;
reflecting the position and action of the user based on the recognition action information recognized by the action recognition apparatus as the user operation; and
updating the operation guidance of the sub window in accordance with the user operation reflected by the action reflection unit.

5. The method according to claim 4, wherein
displaying an icon representing the action of a gesture indicating the start of an operation supporting display processing in the initial screen of the sub window as the operation guidance.

6. The method according to claim 4, wherein
moving the display position of the sub window in the case that the indicator pointer by the user superimposes over the sub window as the recognition result of the action recognition apparatus.
